(19) United States
(12) Patent Application Publication
(10) Pub. No.: US 2025/0097627 A1
(43) Pub. Date: Mar. 20, 2025

(54) LOUDSPEAKER SYSTEM, SIGNAL PROCESSING DEVICE, AND SIGNAL PROCESSING METHOD

(71) Applicant: Panasonic Automotive Systems Co., Ltd., Kanagawa (JP)

(72) Inventors: Fumiyasu KONNO, Osaka (JP); Tatsuya SHIMIZU, Hyogo (JP)

(73) Assignee: Panasonic Automotive Systems Co., Ltd., Kanagawa (JP)

(21) Appl. No.: 18/824,542

(22) Filed: Sep. 4, 2024

(30) Foreign Application Priority Data
Sep. 19, 2023 (JP) 2023-151643

(51) Int. Cl. H04R 1/22

(52) U.S. Cl. CPC H04R 1/22; H04R 2499/13

(57) ABSTRACT

A loudspeaker system includes: a first vibration actuator that is fixed to a first vibration face and imparts vibration to the first vibration face to cause the first vibration face to emit sound; and a first tweeter that outputs sound in a high-frequency range.

### CROSS REFERENCE TO RELATED APPLICATION

The present application is based on and claims priority of Japanese Patent Application No. 2023-151643 filed on Sep. 19, 2023.

### FIELD

The present disclosure relates to a loudspeaker system, a signal processing device, and a signal processing method.

### BACKGROUND

Conventionally, an acoustic device using a vibration actuator and a loudspeaker is known (see, for example, Patent Literature (PTL) 1).

### CITATION LIST

### Patent Literature

PTL 1: Japanese Unexamined Utility Model (Registration) Application Publication No. H02-883

### SUMMARY

However, the acoustic device in PTL 1 can be improved upon.

In view of this, the present disclosure provides a loudspeaker system, a signal processing device, and a signal processing method that are capable of improving upon the related art.

A loudspeaker system according to an aspect of the present disclosure includes: a vibration actuator that is fixed to a first vibration face and imparts vibration to the first vibration face to cause the first vibration face to emit sound; and a tweeter that outputs sound in a high-frequency range.

A signal processing device according to an aspect of the present disclosure includes: a signal obtainer that obtains sound source data; an ultrasonic generator that generates an ultrasonic signal for ultrasound, based on the sound source data obtained; and a low-frequency generator that generates a low-frequency signal for low-frequency vibration, based on the sound source data obtained, wherein the ultrasonic generator: adjusts a pitch of the sound source data by a factor of n, n being a real number greater than 1; extracts a first frequency component included in the sound source data whose pitch has been adjusted by the factor of n, the first frequency component being greater than or equal to 20 kHz; and generates the ultrasonic signal by adding the first frequency extracted to the sound source data obtained, and the low-frequency generator: adjusts the pitch of the sound source data obtained by a factor of 1/l, l being a real number greater than 1; extracts a second frequency component included in the sound source data whose pitch has been adjusted by the factor of 1/l, the second frequency component being less than or equal to 90 Hz; and generates the low-frequency signal by adding the second component extracted to the sound source data obtained.

A signal processing method according to an aspect of the present disclosure includes: obtaining sound source data; generating an ultrasonic signal for ultrasound, based on the sound source data obtained; and generating a low-frequency signal for low-frequency vibration, based on the sound source data obtained, wherein in the generating of the ultrasonic signal: a pitch of the sound source data is adjusted by a factor of n, n being a real number greater than 1; a first frequency component included in the sound source data whose pitch has been adjusted by the factor of n is extracted, the first frequency component being greater than or equal 20 kHz; and the ultrasonic signal is generated by adding the first frequency extracted to the sound source data obtained, and in the generating of the low-frequency signal: the pitch of the sound source data obtained is adjusted by a factor of 1/l, l being a real number greater than 1; a second frequency component included in the sound source data whose pitch has been adjusted by the factor of 1/l is extracted, the second frequency component being less than or equal to 90 Hz; and the low-frequency signal is adjusted by adding the second component extracted to the sound source data obtained.

According to an aspect of the present disclosure, a loudspeaker system, and so on, capable of improving upon the related art can be realized.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating the configuration of a loudspeaker system according to an embodiment.

FIG. 2 is a block diagram illustrating the functional configuration of a signal processing device according to the embodiment.

FIG. 3 is a diagram illustrating the configuration of a first loudspeaker according to the embodiment.

FIG. 4 is a graph illustrating characteristics of the first loudspeaker according to the embodiment.

FIG. 5 is a flowchart illustrating the operation of the signal processing device according to the embodiment.

FIG. 6A is a flowchart illustrating an ultrasonic signal generating operation according to the embodiment.

FIG. 6B is a flowchart illustrating a low-frequency signal generating operation according to the embodiment.

FIG. 7 is a diagram illustrating the configuration of a loudspeaker according to Variation 1 of the embodiment.

FIG. 8 is a diagram illustrating the configuration of a loudspeaker system according to Variation 2 of the embodiment.

FIG. 9 is a diagram illustrating an installation example of a first sub-vibration actuator and a second sub-vibration actuator according to Variation 2 of the embodiment.

FIG. 10 is a diagram illustrating a first application example of the loudspeaker system according to the embodiment, and so on.

FIG. 11 is a diagram illustrating a second application example of the loudspeaker system according to the embodiment, and so on.

FIG. 12 is a diagram illustrating a third application example of the loudspeaker system according to the embodiment, and so on.

FIG. 13 is a diagram illustrating a fourth application example of the loudspeaker system according to the embodiment, and so on.

### DESCRIPTION OF EMBODIMENTS

### (Circumstances Leading to the Present Disclosure)

The aforementioned acoustic device in PTL 1 is problematic in that reproduction in the high-frequency range is difficult, and the reproduction band is narrow.

In view of this, the present disclosure provides, as a loudspeaker system, and so on, capable of improving on the related art, a loudspeaker system, a signal processing device, and a signal processing method that realize a reproduction band wider than that of a conventional device, and so on.

A loudspeaker system according to a first aspect of the present disclosure includes: a vibration actuator that is fixed to a first vibration face and imparts vibration to the first vibration face to cause the first vibration face to emit sound; and a tweeter that outputs sound in a high-frequency range.

Accordingly, since the loudspeaker system includes a tweeter, it is possible to output a sound in a higher frequency range (ultrasonic region, for example) compared to a case where a tweeter is not included. Accordingly, a loudspeaker system having a wider reproduction band than a conventional loudspeaker system can be realized.

Furthermore, for example, a loudspeaker system according to a second aspect is the loudspeaker system according to the first aspect, and may further include: a first sub-vibration actuator that is fixed to a second vibration face and imparts vibration to the second vibration face to cause the second vibration face to emit sound; and a second sub-vibration actuator that is fixed to a third vibration face and imparts vibration to the third vibration face to cause the third vibration face to emit sound.

Accordingly, since the vibration actuator enables sound in the low-frequency range to be effectively outputted, the reproduction band in the low-frequency range can be made wider. Accordingly, a loudspeaker system having an even wider reproduction band than a conventional loudspeaker system can be realized.

Furthermore, for example, a loudspeaker system according to a third aspect is the loudspeaker system according to the second aspect, in which the first sub-vibration actuator and the second sub-vibration actuator may be provided in a cushion member that a lower back portion of a person comes into contact with when the person is seated on a seat on which the cushion member is placed, and the first sub-vibration actuator and the second sub-vibration actuator may output sound toward the lower back portion.

Accordingly, since the person's body is made to feel the vibration, it is possible to add a bassy feel.

Furthermore, for example, a loudspeaker system according to a fourth aspect is the loudspeaker system according to any one of the first to fourth aspects, in which the tweeter may be disposed overlapping with the vibration actuator when viewed from an axial direction of the vibration actuator.

Accordingly, a reproduction band that is wider than that of a conventional loudspeaker system can be realized using a loudspeaker system in which the tweeter and the vibration actuator disposed in an overlapping manner. Furthermore, since the tweeter and the vibration actuator are disposed in an overlapping manner, the plan view area can be reduced, and thus space saving can be realized.

Furthermore, for example, a loudspeaker system according to a fifth aspect is the loudspeaker system according to any one of the first to third aspects, in which the tweeter may be disposed side by side with the vibration actuator when viewed from an axial direction of the vibration actuator.

Accordingly, a reproduction band that is wider than that of a conventional loudspeaker system can be realized using a loudspeaker system in which the tweeter and the vibration actuator disposed side by side.

Furthermore, for example, a loudspeaker system according to a sixth aspect is the loudspeaker system according to any one of the first to fifth aspects, in which the sound in the high-frequency range outputted by the tweeter may include, from among a sound in an audible frequency range and a sound in an inaudible frequency range higher than the audible frequency range, at least the sound in the inaudible frequency range.

Accordingly, since the tweeter outputs sound in the inaudible frequency range, the reproduction band can be made wider compared to a case where only sound in the audible frequency range is outputted.

Furthermore, for example, a loudspeaker system according to a seventh aspect is the loudspeaker system according to the sixth aspect, in which the sound in the high-frequency range outputted by the tweeter may further include the sound in the audible frequency range.

Accordingly, since the tweeter outputs sound in the audible frequency range, this enables a person to listen to sound in the high-frequency range-side of the audible frequency range.

Furthermore, for example, a signal processing device according to an eighth aspect includes: a signal obtainer that obtains sound source data; an ultrasonic generator that generates an ultrasonic signal for ultrasound, based on the sound source data obtained; and a low-frequency generator that generates a low-frequency signal for low-frequency vibration, based on the sound source data obtained. The ultrasonic generator: adjusts a pitch of the sound source data by a factor of n, n being a real number greater than 1; extracts a first frequency component included in the sound source data whose pitch has been adjusted by the factor of n, the first frequency component being greater than or equal to 20 kHz; and generates the ultrasonic signal by adding the first frequency extracted to the sound source data obtained. The low-frequency generator: adjusts the pitch of the sound source data obtained by a factor of 1/l, l being a real number greater than 1; extracts a second frequency component included in the sound source data whose pitch has been adjusted by the factor of 1/l, the second frequency component being less than or equal to 90 Hz; and generates the low-frequency signal by adding the second component extracted to the sound source data obtained.

Accordingly, since an ultrasonic signal and a low-frequency signal are generated, by having the generated signals outputted by a loudspeaker, the frequency band (reproduction band) of the sound outputted from the loudspeaker can be made wider than that of a conventional loudspeaker.

Furthermore, for example, a signal processing device according to a ninth aspect is the signal processing device according to the eight aspect, and may further include: an outputter that outputs the ultrasonic signal generated to the tweeter included in the loudspeaker system according to any one of the first to seventh aspects, and outputs the low-frequency signal generated to the vibration actuator included in the loudspeaker system.

Accordingly, by outputting an ultrasonic signal from the tweeter and outputting a low-frequency signal from the vibration actuator, the reproduction band in each of the high-frequency range and the low-frequency range can be effectively made wider.

Furthermore, for example, a signal processing method according to a tenth aspect includes: obtaining sound source data; generating an ultrasonic signal for ultrasound, based on the sound source data obtained; and generating a low-frequency signal for low-frequency vibration, based on the sound source data obtained. In the generating of the ultrasonic signal: a pitch of the sound source data is adjusted by a factor of n, n being a real number greater than 1; a first frequency component included in the sound source data whose pitch has been adjusted by the factor of n is extracted, the first frequency component being greater than or equal 20 kHz; and the ultrasonic signal is generated by adding the first frequency extracted to the sound source data obtained. In the generating of the low-frequency signal: the pitch of the sound source data obtained is adjusted by a factor of 1/l, l being a real number greater than 1; a second frequency component included in the sound source data whose pitch has been adjusted by the factor of 1/l is extracted, the second frequency component being less than or equal to 90 Hz; and the low-frequency signal is adjusted by adding the second component extracted to the sound source data obtained.

Accordingly, the same advantageous effect as with the signal processing device described above is achieved.

It is to be noted that these general or specific aspects may be implemented as a system, a method, an integrated circuit, a computer program, or a non-transitory computer-readable recording medium such as a CD-ROM, or may be implemented as any combination of a system, a method, an integrated circuit, a computer program, and a recording medium. The program may be stored in advance in the recording medium or may be supplied to the recording medium via a wide area communication network such as the Internet.

Hereinafter, embodiments will be described in detail with reference to the Drawings.

It is to be noted that each of the following embodiments indicate a specific example of the present disclosure. The numerical values, shapes, constituent elements, the arrangement and connection of the constituent elements, steps, the processing order of the steps, etc., indicated in the following embodiments are mere examples, and thus are not intended to limit the present disclosure. Among the constituent elements described in the following embodiments, constituent elements not recited in any one of the independent claims will be described as optional constituent elements.

Furthermore, the respective figures are schematic diagrams and are not necessarily precise illustrations. Therefore, for example, the scaling, and so on, depicted in the drawings is not necessarily uniform. Furthermore, in the figures, elements which are substantially the same are given the same reference signs, and overlapping description is omitted or simplified.

Additionally, in the present Specification, terms indicating relations between elements, such as “the same” and so on; numerical values; and numerical ranges are not strictly defined and include a substantially same range which includes, for example, a margin of error of a few percent (or approximately 10%).

Furthermore, in the present Specification, unless otherwise stated, ordinal numbers such as “first”, “second”, and so on, do not define the number or order of elements, and are used for the purpose of distinguishing between elements of the same type to avoid confusion.

### Embodiment

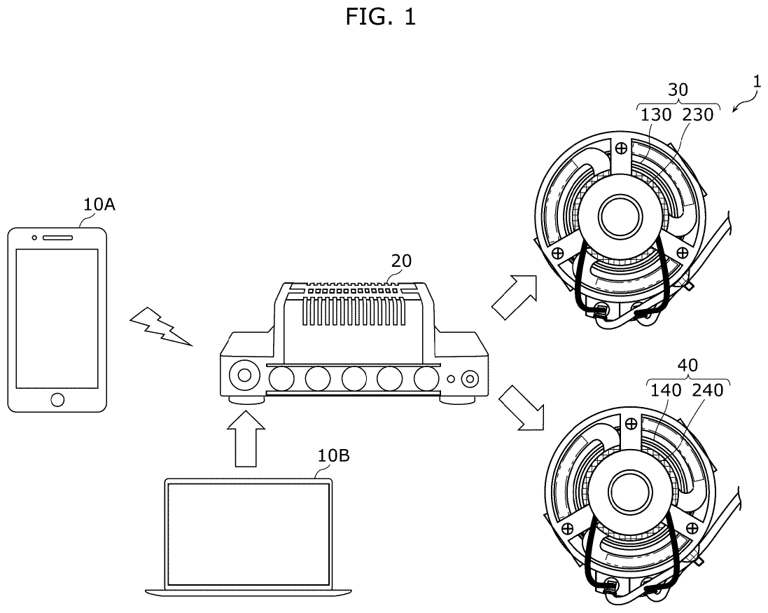

Hereinafter, a loudspeaker system according to the present embodiment will be described with reference to FIG. 1 to FIG. 6B.

### [1. Configuration of Loudspeaker System]

First, with reference to FIGS. 1 to 4, the configuration of a loudspeaker system according to the present embodiment will be described. FIG. 1 is a diagram illustrating the configuration of loudspeaker system 1 according to the present embodiment.

As illustrated in FIG. 1, loudspeaker system 1 includes wireless device 10A, external device 10B, signal processing device 20, first loudspeaker 30, and second loudspeaker 40. Loudspeaker system 1 may include at least one of first loudspeaker 30 or second loudspeaker 40. Signal processing device 20 may also be implemented as a standalone device.

Loudspeaker system 1 is a system for causing sound to be emitted from first loudspeaker 30 and second loudspeaker 40 using signals generated based on sound source data inputted from wireless device 10A or external device 10B.

Wireless device 10A, which is connected to signal processing device 20 to be capable of wireless communication therebetween, outputs sound source data to signal processing device 20. Examples of wireless device 10A include, but are not limited to, a smartphone and a tablet terminal. The wireless communication is performed based on a wireless communication standard, for example, but not limited to, Wi-Fi (R), Bluetooth (R), or ZigBee (R).

External device 10B, which is connected to signal processing device 20 to be capable of wired communication therebetween, outputs sound source data to signal processing device 20. Examples of external device 10B include, but are not limited to, a personal computer (PC) and a universal serial bus (USB) terminal. Examples of the wired communication include, but are not limited to, power line communication (PLC)-based communication and wired LAN-based communication.

The sound source data may be data that includes no frequency components greater than or equal to 20 kHz. Examples of the sound source data may include music data and ambient-sound data. For example, the sound source data may be obtained from a music source such as a compact disc (CD). The sound source data may be data for generating artificial traveling sound corresponding to the traveling state of a moving body such as a vehicle. The artificial traveling sound is, for example, simulated engine sound.

Signal processing device 20 is an information processing device for generating, from the sound source data obtained, an ultrasonic signal for ultrasound and a low-frequency signal for low-frequency vibration. It is known that providing sound including frequency components greater than or equal to 20 kHz (e.g., sound in an inaudible frequency range) to a person brings about the hypersonic effect that improves the person's mental and physical states. Signal processing device 20 thus generates, as an ultrasonic signal, sound source data for providing the hypersonic effect. It is also known that providing sound including a gamma-wave (40 Hz) frequency component to a person induces gamma waves in the person's brain, bringing about the gamma wave effect that reduces stress on the person and improves the person's physical conditions. Signal processing device 20 may thus further generate, as a low-frequency signal, sound source data for providing the gamma wave effect.

In the present embodiment, signal processing device 20 is implemented by a DSP amplifier that integrates a digital signal processor (DSP) for processing digital signals and a power amplifier for amplifying input signals and outputting the amplified signals to thereby drive loudspeakers. However, this is not limiting. Signal processing device 20 may have at least the DSP out of the DSP and the power amplifier.

Signal processing device 20 is configured to be able to receive power through both a cigarette lighter socket (for in-vehicle use) and an AC adapter (for home use).

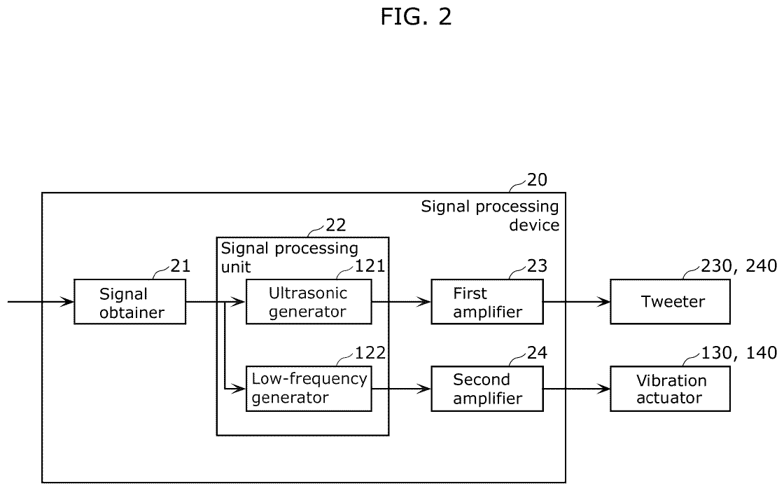

FIG. 2 is a block diagram illustrating the functional configuration of signal processing device 20 according to the present embodiment.

As illustrated in FIG. 2, signal processing device 20 includes signal obtainer 21, signal processing unit 22, first amplifier 23, and second amplifier 24. Signal processing device 20 includes components such as a processor and memory. The memory, which may be read-only memory (ROM) or random-access memory (RAM), can store programs to be executed by the processor. Signal obtainer 21, signal processing unit 22, first amplifier 23, and second amplifier 24 may be implemented by the processor or the like that executes programs stored in the memory.

Signal obtainer 21 obtains sound source data from wireless device 10A or external device 10B. Signal obtainer 21 may also obtain sound source data from a storage (not shown) included in signal processing device 20.

Based on the sound source data obtained by signal obtainer 21, signal processing unit 22 generates an ultrasonic signal for ultrasound and a low-frequency signal for low-frequency vibration. Signal processing unit 22 includes ultrasonic generator 121 that generates an ultrasonic signal for ultrasound based on sound source data, and low-frequency generator 122 that generates a low-frequency signal for low-frequency vibration based on the sound source data.

Ultrasonic generator 121 includes, for example, a high-pass filter. For example, ultrasonic generator 121 is implemented with a digital filter, although it may be implemented with an analog filter.

Low-frequency generator 122 includes, for example, a low-pass filter. For example, low-frequency generator 122 is implemented with a digital filter, although it may be implemented with an analog filter.

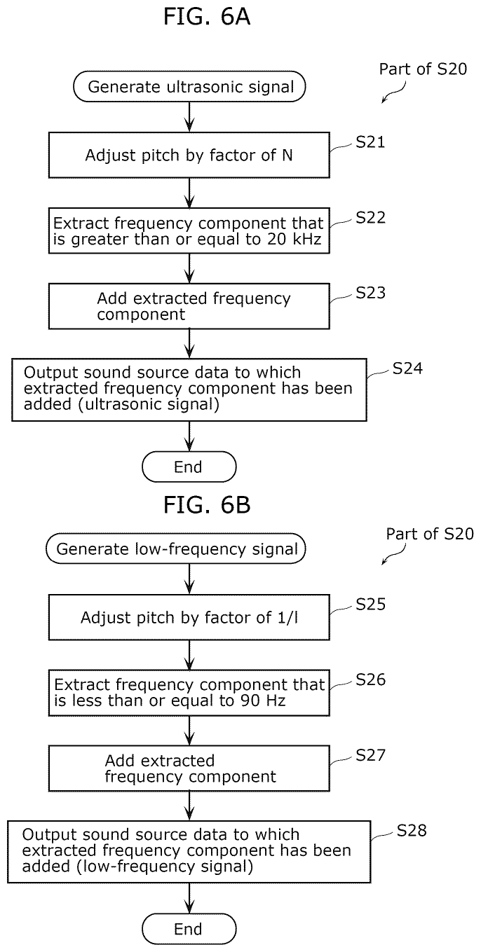

The methods in which ultrasonic generator 121 generates the ultrasonic signal and low-frequency generator 122 generates the low-frequency signal will be described below with reference to FIGS. 6A and 6B.

First amplifier 23 causes tweeters (first tweeter 230 and second tweeter 240) to output ultrasound based on the ultrasonic signal. First amplifier 23 causes first tweeter 230 and second tweeter 240 to output ultrasound by amplifying the ultrasound signal and outputting the amplified signal to first tweeter 230 and second tweeter 240. First amplifier 23 functions as an outputter.

Second amplifier 24 causes vibration actuators (first vibration actuator 130 and second vibration actuator 140) to output sound based on the low-frequency signal. Second amplifier 24 causes first vibration actuator 130 and second vibration actuator 140 to output low-frequency vibration by amplifying the low-frequency signal and outputting the amplified signal to first vibration actuator 130 and second vibration actuator 140. Second amplifier 24 functions as the outputter.

Referring again to FIG. 1, first loudspeaker 30 includes first vibration actuator 130 and first tweeter 230.

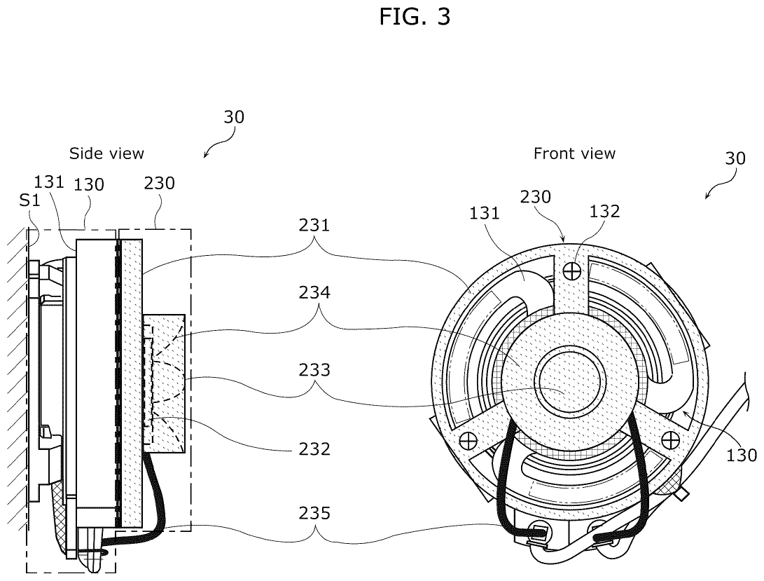

First vibration actuator 130 outputs low-frequency vibration based on the low-frequency signal. First vibration actuator 130 has no diaphragm (cone paper), and imparts vibration to a vibration face (e.g., first vibration face S1 shown in FIG. 3) to which it is fixed, thereby causing the vibration face to emit sound. First vibration actuator 130 is also called an exciter. For example, first vibration actuator 130 outputs gamma waves (e.g., of 40 Hz). First vibration actuator 130 outputs sound mainly in the frequency band from 40 Hz to 90 Hz (low-frequency vibration), for example.

First vibration actuator 130 may further be able to output sound in the frequency band from 90 Hz to 120 kHz. It is to be noted that, even if first vibration actuator 130 can output sound in a high-frequency range greater than or equal to 20 kHz, sound pressure levels in the high-frequency range will be lower than those of sound from the tweeters and insufficient as output sound in the high-frequency range. Loudspeaker system 1 may also include other vibration actuators or loudspeakers capable of outputting sound in the frequency band from 90 Hz to 120 kHz.

First vibration actuator 130 includes a coil and a magnetic circuit, and the coil is fixed to first vibration face S1. First vibration actuator 130 causes first vibration face S1 to vibrate according to the vibration of the coil moving relative to the magnetic circuit. Alternatively, first vibration actuator 130 may have the magnetic circuit fixed to first vibration face S1. In this case, first vibration actuator 130 causes first vibration face S1 to vibrate according to the vibration of the magnetic circuit moving relative to the coil.

First vibration face S1 is, for example, a rectangular board member. For example, first vibration face S1 is made of wood, resin, or metal. First vibration actuator 130 is fixed to first vibration face S1 with double-sided adhesive tape or screws.

First tweeter 230 outputs sound in a high-frequency range above a certain frequency. For example, first tweeter 230 outputs sound mainly in the frequency band from 20 kHz to 150 kHz (ultrasound). Sound in the high-frequency range outputted by first tweeter 230 may include, of sound in an audible frequency range (e.g., lower than 20 kHz) and sound in an inaudible frequency range (e.g., higher than or equal to 20 kHz) higher than the audible frequency range, at least sound in the inaudible frequency range. Sound in the high-frequency range outputted by first tweeter 230 may further include sound in the audible frequency range. First tweeter 230 may be able to output sound higher than or equal to, for example, any one of frequencies higher than or equal to 15 kHz and below 20 kHz. For example, first tweeter 230 may output sound higher than or equal to 19 kHz, sound higher than or equal to 18 kHz, sound higher than or equal to 17 kHz, sound higher than or equal to 16 kHz, or sound higher than or equal to 15 kHz.

Thus, first loudspeaker 30 is configured to be able to reproduce sound up to an ultrasonic region.

Second loudspeaker 40 includes second vibration actuator 140 and second tweeter 240. Second vibration actuator 140 has the same configuration as first vibration actuator 130, and second tweeter 240 has the same configuration as first tweeter 230. These components will therefore not be described.

Here, with reference to FIG. 3, the arrangement of the vibration actuators and the tweeters will be described. FIG. 3 is a diagram illustrating the configuration (arrangement) of first loudspeaker 30 according to the present embodiment. First loudspeaker 30 and second loudspeaker 40 have the same configuration, and the following description takes first loudspeaker 30 as an example. It should be noted that the dot hatching in FIG. 3 is provided, not to indicate a cross-section, but to clearly indicate same structural elements in the side view and front view illustrations.

As illustrated in FIG. 3, first loudspeaker 30 has first tweeter 230 disposed over first vibration actuator 130. That is, first tweeter 230 and first vibration actuator 130 are disposed in an overlapping manner in a plan view. For example, when viewed from the axial direction of first vibration actuator 130 (the direction orthogonal to the sheet surface of FIG. 3), first tweeter 230 is disposed at a position corresponding to the central portion of first vibration actuator 130. First tweeter 230 and first vibration actuator 130 may be coaxially disposed. The plan view means a view from the axial direction of first vibration actuator 130 (the direction orthogonal to the sheet surface of FIG. 3).

First vibration actuator 130 includes vibration actuator section 131 that outputs low-frequency vibration.

First tweeter 230 includes tweeter section 231, piezoelectric element 232, diaphragm 233, horn 234, and lead wire 235. Having piezoelectric element 232, first tweeter 230 in the present embodiment is what is called a piezoelectric tweeter.

Tweeter section 231 is an assembly member provided for attaching first tweeter 230 to first vibration actuator 130. Tweeter section 231 includes a ring-shaped first portion, and connecting portions for connecting the first portion to components such as horn 234 and diaphragm 233. Fastening members 132 are attached to the connecting portions. Although three connecting portions are provided in the example in FIG. 3, at least two connecting portions may be provided. Examples of fastening members 132 include screws and bolts.

Piezoelectric element 232, which is provided in contact with diaphragm 233, is an element displaced to extend and contract according to changes in applied voltage (accumulated electric charge). For example, piezoelectric element 232 is stuck to diaphragm 233. Supplying an ultrasonic signal to piezoelectric element 232 causes sound waves to be emitted from piezoelectric element 232 via diaphragm 233.

Diaphragm 233 is a dome-shaped member vibrated by piezoelectric element 232 according to an input ultrasonic signal to generate sound waves. For example, diaphragm 233 has piezoelectric element 232 stuck thereto, so that it vibrates based on the extension and contraction of piezoelectric element 232 caused by voltage applied to piezoelectric element 232.

Horn 234 is placed for purposes such as increasing the sound pressure of sound outputted from diaphragm 233 and controlling the directivity of sound outputted from diaphragm 233. Horn 234 is formed in tubular (conical) shape such that its diameter gradually increases along the axial direction from tweeter section 231 toward the side opposite to vibration actuator section 131.

Although the above description illustrates the use of piezoelectric element 232 as a vibration element of first tweeter 230, this is not limiting. For example, the vibration element may be configured as a voice coil in which a small and high-performance magnet such as a neodymium magnet is used for a magnetic circuit.

Lead wire 235 connects signal processing device 20 to an external electrode (not shown) of piezoelectric element 232 to convey ultrasonic signals generated by signal processing device 20 to piezoelectric element 232. Because lead wire 235 is thin and soft, using lead wire 235 as a wire connected to piezoelectric element 232 can facilitate electric connection between lead wire 235 and piezoelectric element 232. The wire is not limited to lead wire 235 and may be any wire capable of electrically interconnecting signal processing device 20 and piezoelectric element 232. Lead wire 235 may also be connected to a terminal of first vibration actuator 130 in parallel.

Tweeter section 231 and a suspension of first vibration actuator 130 may be fixed together to first vibration actuator 130, for example using fastening members 132. The suspension, which may be an elastic member for example, is disposed between tweeter section 231 and first vibration actuator 130 to prevent vibration of first vibration actuator 130 from propagating to tweeter section 231. The elastic member may typically be made of rubber such as polyurethane rubber or synthetic rubber, but is not limited thereto, and may be made of any other elastic material other than rubber.

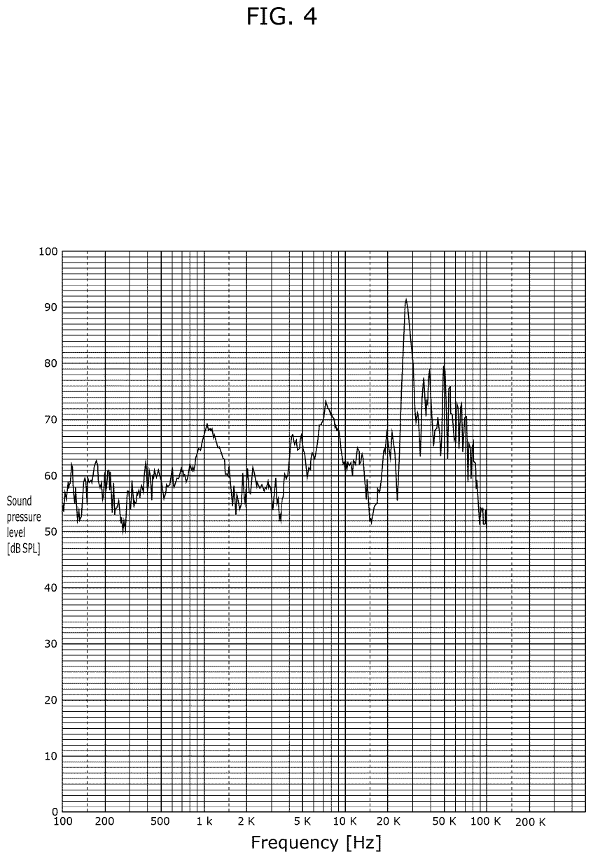

Here, with reference to FIG. 4, characteristics of loudspeaker system 1 configured as above will be described. FIG. 4 is a diagram illustrating characteristics of first loudspeaker 30 according to the present embodiment. Characteristics of second loudspeaker 40 are the same as those of first loudspeaker 30 and therefore will not be described. For convenience, FIG. 4 shows only sound pressure levels [dB SPL (Sound Pressure Level)] from 100 Hz to 100 kHz.

As illustrated in FIG. 4, having first tweeter 230, first loudspeaker 30 can output sound in an ultrasonic region from 20 kHz to 100 kHz at above a certain sound pressure level. This would be difficult if first loudspeaker 30 had only first vibration actuator 130.

An exemplary sound pressure level of sound of 20 kHz to 150 kHz from first tweeter 230 and second tweeter 240 measured at a distance of 1 m is 70 dB, which may be an average value.

Thus, loudspeaker system 1 according to the present embodiment can reproduce sound up to an ultrasonic region. Loudspeaker system 1 reproduces sound in the high-frequency range including the ultrasonic region using first tweeter 230 and second tweeter 240, and reproduces sound in the low-frequency range (low-frequency region) using first vibration actuator 130 and second vibration actuator 140.

Loudspeaker system 1 configured as above can, with at least one of first tweeter 230 or second tweeter 240, make the reproduction band of the high-frequency range wider than that which would be obtained by loudspeaker system 1 with only the vibration actuators. That is, with at least one of first tweeter 230 or second tweeter 240, loudspeaker system 1 having a reproduction band wider than that of conventional systems can be achieved. Accordingly, leads to improved sound quality and improved sound image localization, enabling a wider sound field.

Conventionally, audio systems with vibration actuators and loudspeakers have existed. However, it has been difficult to change frequency characteristics, as well as to reproduce sound in the high-frequency range. This has resulted in a narrow reproduction band and unsatisfactory sound quality and sound image localization. Loudspeaker system 1 according to the present embodiment can solve these previous problems by virtue of at least one of first tweeter 230 or second tweeter 240 that facilitates the reproduction of sound in the high-frequency range. This will also effectively improve the directivity of sound in the high-frequency range, the directional recognizability of sound, and the clarity of sound.

### [2. Operation of Loudspeaker System]

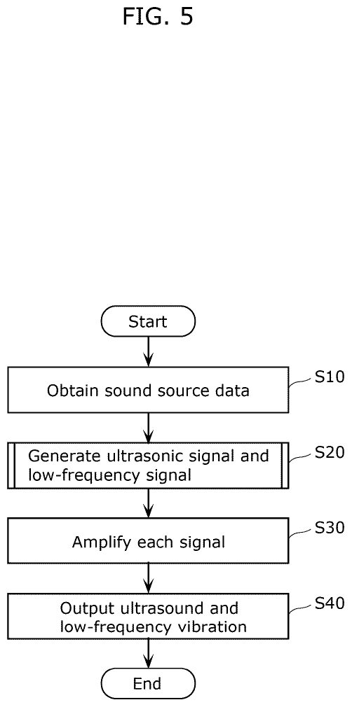

Now, with reference to FIGS. 5 to 6B, the operation of loudspeaker system 1 configured as above will be described. FIG. 5 is a flowchart illustrating the operation (a signal processing method) of loudspeaker system 1 according to the present embodiment. FIG. 5 mainly illustrates the operation of signal processing device 20 in loudspeaker system 1.

As illustrated in FIG. 5, signal obtainer 21 in signal processing device 20 obtains sound source data (S10). For example, signal obtainer 21 obtains the sound source data from at least one of wireless device 10A or external device 10B. If the sound source data obtained is data recorded on a CD, the data is of 44.1 kHz sampling frequency, 16 bits, and two channels. As will be described in detail below, a frequency component greater than or equal to 20 kHz is added at step S23 to the sound source data obtained by signal obtainer 21. However, for data of 44.1 kHz sampling frequency, only a frequency component up to half the frequency, i.e., 22.05 kHz, can be added to the sound source data.

For this reason, if the sound source data is obtained from a CD, signal obtainer 21 upsamples the sound source data obtained. This allows generating sound source data of, for example, 192 kHz sampling frequency, 24 to 32 bits, and two channels (e.g., high-resolution sound source data), to which a frequency component up to 96 kHz can then be added. Signal obtainer 21 may also directly obtain such high-resolution sound source data as the sound source data, in which case signal obtainer 21 need not perform upsampling. Reproducing high-resolution sound source data can effectively widen the sound image.

Based on the sound source data, signal processing unit 22 in signal processing device 20 generates an ultrasonic signal for ultrasound and a low-frequency signal for low-frequency vibration (S20). In signal processing unit 22, ultrasonic generator 121 generates the ultrasonic signal for ultrasound based on the sound source data, and low-frequency generator 122 generates the low-frequency signal for low-frequency vibration based on the sound source data.

Here, with reference to FIGS. 6A and 6B, the details of step S20 will be described. FIG. 6A is a flowchart illustrating the operation of generating the ultrasonic signal (the signal processing method) according to the present embodiment. The process steps illustrated in FIG. 6A are performed by ultrasonic generator 121.

Ultrasonic generator 121 adjusts the pitch (the height of sound) of the sound source data obtained by signal obtainer 21 by a factor of n (n is a real number greater than 1) (S21). Increasing the pitch of the sound source data by a factor of n increases all the frequency components of the sound source data by n times to shift them toward the higher-frequency side. Although not specifically limited, n is set to a value such that the pitch-adjusted sound source data includes a frequency component greater than or equal to 20 kHz. For example, ultrasonic generator 121 determines the greatest frequency component in the sound source data. If the greatest frequency component is smaller than 20 kHz, n may be set to be greater than or equal to a value resulting from dividing 20 kHz by the greatest frequency component. For example, n may be the m-th power of 2 (m is an integer greater than or equal to 1). That is, ultrasonic generator 121 may adjust the pitch of the obtained sound source data by a factor of the m-th power of 2 (by a factor of 2, 4, 8, . . . ). Different values of m may lead to achieving different degrees of effect of improving the mental and physical states obtained. In this respect, signal processing device 20 may include an input unit that receives information indicating the degree of effect of improving the mental and physical states desired by the user to achieve. Ultrasonic generator 121 may then adjust the value of m according to the information received by the input unit. This allows the user to obtain a user-desired degree of improvement effect.

In addition to the pitch, ultrasonic generator 121 may adjust the sound pressure level. In this case, ultrasonic generator 121 may increase or decrease the sound pressure level.

In the above-described example, n is set to a value such that the pitch-adjusted sound source data includes a frequency component greater than or equal to 20 kHz. Alternatively, n may be set to a value such that the pitch-adjusted sound source data includes a frequency component greater than or equal to 15 kHz, for example. That is, n may be set to a value such that the pitch-adjusted sound source data includes a frequency component in the audible frequency range.

Ultrasonic generator 121 extracts a frequency component greater than or equal to 20 kHz in the pitch-adjusted sound source data (S22). As the frequency component greater than or equal to 20 kHz in the pitch-adjusted sound source data, ultrasonic generator 121 may extract, using a high-pass filter, a frequency component greater than or equal to 40 kHz, for example.

It is to be noted that ultrasonic generator 121 may first extract a frequency component greater than or equal to a particular frequency (e.g., 4 kHz) in the sound source data obtained, and then multiply the extracted frequency component by n (e.g., 10). In this manner, a frequency component greater than or equal to 20 kHz can still be extracted.

Ultrasonic generator 121 adds the frequency component extracted at step S22 to the sound source data obtained by signal obtainer 21 at step S10 (S23). Thus, sound source data (i.e., an ultrasonic signal) including a frequency component greater than or equal to 20 kHz can be generated.

Ultrasonic generator 121 outputs the sound source data (an ultrasonic signal) to which the frequency component extracted at step S22 has been added (S24). For example, ultrasonic generator 121 outputs the sound source data to first amplifier 23, or alternatively may output the sound source data to components such as the tweeters (first tweeter 230 and second tweeter 240). The user can thus listen to sound (such as music or ambient sound) represented by the sound source data while also obtaining the hypersonic effect.

It is said that the hypersonic effect is not sufficiently obtained with frequency components from 20 kHz to 40 kHz. To address this, a frequency component greater than or equal to 40 kHz in the pitch-adjusted sound source data may be extracted to generate sound source data including the frequency component greater than or equal to 40 kHz; this sound source data will sufficiently provide the hypersonic effect. That is, from the viewpoint of effectively obtaining the hypersonic effect, a frequency component greater than or equal to 40 kHz may be extracted at step S22.

Next, with reference to FIG. 6B, low-frequency signal generation will be described. FIG. 6B is a flowchart illustrating the operation of generating the low-frequency signal (the signal processing method) according to the present embodiment. The process steps illustrated in FIG. 6B are performed by low-frequency generator 122.

Low-frequency generator 122 adjusts the pitch (the height of sound) of the sound source data obtained by signal obtainer 21 by a factor of 1/l (I is a real number greater than 1) (S25). Multiplying the pitch of the sound source data by a factor of 1/l reduces all the frequency components of the sound source data to 1/l the magnitude to shift them toward the lower-frequency side. Although not specifically limited, l is set to a value such that the pitch-adjusted sound source data includes a frequency component less than or equal to 90 Hz. For example, low-frequency generator 122 determines the smallest frequency component in the sound source data. If the smallest frequency component is greater than 90 Hz, 1/l may be set to be smaller than or equal to a value resulting from dividing 90 Hz by the smallest frequency component. For example, l may be the k-th power of 2 (k is an integer greater than or equal to 1). That is, low-frequency generator 122 may adjust the pitch of the obtained sound source data by a factor of 1/(the k-th power of 2) (by a factor of ½, ¼, ⅛, . . . ). Different values of k may lead to achieving different degrees of effect of improving the mental and physical states obtained. In this respect, signal processing device 20 may include an input unit that receives information indicating the degree of effect of improving the mental and physical states desired by the user to achieve. Low-frequency generator 122 may then adjust the value of k according to the information received by the input unit. This allows the user to obtain a user-desired degree of improvement effect.

In addition to the pitch, low-frequency generator 122 may adjust the sound pressure level. In this case, low-frequency generator 122 may increase or decrease the sound pressure level.

Low-frequency generator 122 extracts a frequency component less than or equal to 90 Hz in the pitch-adjusted sound source data (S26). As the frequency component less than or equal to 90 Hz in the pitch-adjusted sound source data, low-frequency generator 122 may extract, using a low-pass filter, a frequency component less than or equal to 70 Hz, for example.

It is to be noted that low-frequency generator 122 may first extract a frequency component less than or equal to a particular frequency (e.g., 800 Hz) in the sound source data obtained, and then multiply the extracted frequency component by 1/l (e.g., 1/10). In this manner, a frequency component less than or equal to 90 Hz can still be extracted.

Low-frequency generator 122 adds the frequency component extracted at step S26 to the sound source data obtained by signal obtainer 21 at step S10 (S27). Thus, sound source data (i.e., a low-frequency signal) including a frequency component less than or equal to 90 Hz can be generated. For example, even if the sound pressure level of a frequency component less than or equal to 90 Hz is insufficient in the sound source data obtained at step S10, low-frequency generator 122 can perform the above processing to generate sound source data adjusted to include a frequency component less than or equal to 90 Hz at a sufficient sound pressure level.

Low-frequency generator 122 outputs the sound source data (a low-frequency signal) to which the frequency component extracted at step S26 has been added (S28). For example, low-frequency generator 122 outputs the sound source data to second amplifier 24, or alternatively may output the sound source data to components such as the vibration actuators (first vibration actuator 130 and second vibration actuator 140). The user can thus listen to sound (such as music or ambient sound) represented by the sound source data.

Referring again to FIG. 5, signal processing device 20 amplifies each of the signals: the ultrasonic signal for ultrasound, and the low-frequency signal for low-frequency vibration (S30). Specifically, first amplifier 23 amplifies the ultrasonic signal, and second amplifier 24 amplifies the low-frequency signal.

Loudspeaker system 1 outputs ultrasound and low-frequency vibration (S40). Specifically, first amplifier 23 outputs the amplified ultrasonic signal to first tweeter 230 and second tweeter 240, and second amplifier 24 outputs the amplified low-frequency signal to first vibration actuator 130 and second vibration actuator 140. First tweeter 230 and second tweeter 240 output ultrasound based on the ultrasonic signal obtained, and first vibration actuator 130 and second vibration actuator 140 output low-frequency vibration based on the low-frequency signal obtained.

Signal processing device 20 operating as above generates, through its unique signal processing, an ultrasonic signal greater than or equal to, e.g., 20 kHz in ultrasonic generator 121. Therefore, the frequency band of the high-frequency range of signals outputted from signal processing device 20 can be widened compared to cases in which such an ultrasonic signal is not generated. Reproducing such signals through the loudspeakers can widen the reproduction band of the high-frequency range of sound outputted from the loudspeakers. This leads to improved sound quality and improved sound image localization, enabling a wider sound field. Signal processing device 20 can solve the above-described previous problems by virtue of at least one of first tweeter 230 or second tweeter 240 that facilitates the reproduction of sound in the high-frequency range.

Signal processing device 20 operating as above also generates, through its unique signal processing, a low-frequency signal less than or equal to, e.g., 90 Hz in low-frequency generator 122. Therefore, the frequency band of the low-frequency range of signals outputted from signal processing device 20 can be widened compared to cases in which such a low-frequency signal is not generated. Reproducing such signals through the loudspeakers can widen the reproduction band of the low-frequency range of sound outputted from the loudspeakers. This leads to improved sound quality and improved sound image localization, enabling a wider sound field.

### Variation 1 of Embodiment

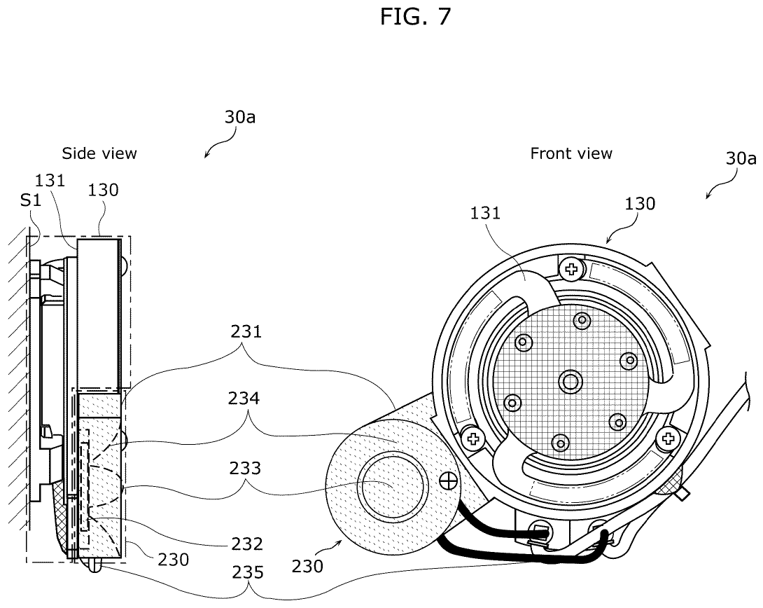

With reference to FIG. 7, a loudspeaker system according to a variation will be described below. The following mainly describes differences between the present variation and the above embodiment and therefore omits or simplifies description of details that are the same as or similar to those of the above embodiment. FIG. 7 is a diagram illustrating the configuration of a loudspeaker (first loudspeaker 30a) according to the present variation. First loudspeaker 30a according to the present variation is different from first loudspeaker 30 according to the above embodiment in the arrangement of the vibration actuators and the tweeters. Although FIG. 7 shows first loudspeaker 30a as a loudspeaker, the second loudspeaker (not shown) may have the same configuration as first loudspeaker 30a. It should be noted that the dot hatching in FIG. 7 is provided, not to indicate a cross-section, but to clearly indicate same structural elements in the side view and front view illustrations.

As illustrated in FIG. 7, first loudspeaker 30a has first tweeter 230 disposed beside first vibration actuator 130. That is, first tweeter 230 and first vibration actuator 130 are disposed side by side in a plan view.

First tweeter 230 and the housing of first vibration actuator 130 may be an integrated unit. Alternatively, first tweeter 230 and parts of first vibration actuator 130 may be incorporated into an integrated unit. Lead wire 235 may be connected to a terminal of first vibration actuator 130 in parallel.

### Variation 2 of Embodiment

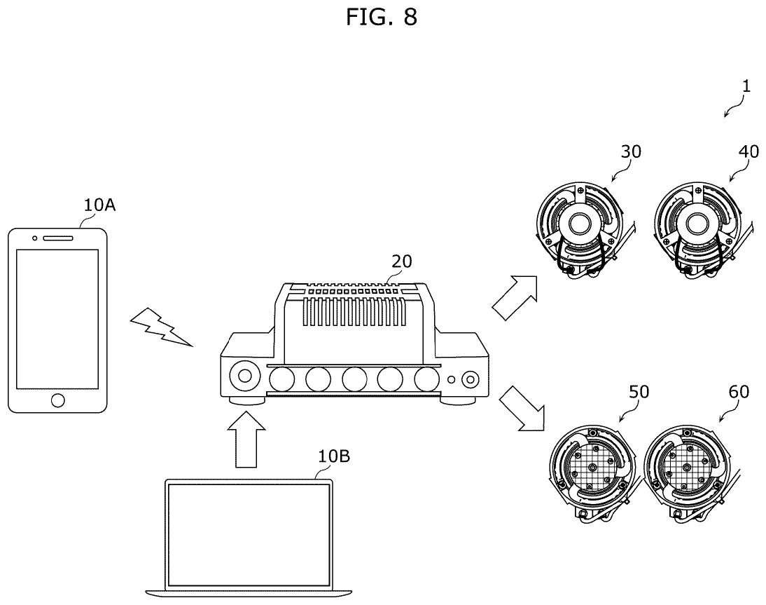

With reference to FIGS. 8 and 9, a loudspeaker system according to another variation will be described below. The following mainly describes differences between the present variation and the above embodiment and therefore omits or simplifies description of details that are the same as or similar to those of the above embodiment. FIG. 8 is a diagram illustrating the configuration of loudspeaker system 1 according to the present variation. Loudspeaker system 1 according to the present variation is different from loudspeaker system 1 according to the above embodiment in that it further includes first sub-vibration actuator 50 and second sub-vibration actuator 60.

As illustrated in FIG. 8, in addition to the components of loudspeaker system 1 according to the above embodiment, loudspeaker system 1 according to the present variation includes the following components: first sub-vibration actuator 50 that is fixed to a second vibration face (e.g., second vibration face S2 shown in figures such as FIG. 9) and imparts vibration to second vibration face S2 to cause second vibration face S2 to emit sound; and second sub-vibration actuator 60 that is fixed to a third vibration face (e.g., third vibration face S3 shown in figures such as FIG. 9) and imparts vibration to third vibration face S3 to cause third vibration face S3 to emit sound.

First sub-vibration actuator 50 and second sub-vibration actuator 60 output low-frequency vibration. First sub-vibration actuator 50 and second sub-vibration actuator 60 may output low-frequency vibration in synchronization with output from first vibration actuator 130 and second vibration actuator 140.

First sub-vibration actuator 50 and second sub-vibration actuator 60 have no diaphragm (cone paper), and impart vibration to vibration faces (second vibration face S2 and third vibration face S3) to which they are fixed, thereby causing the vibration faces to emit sound. First sub-vibration actuator 50 and second sub-vibration actuator 60 are also called exciters. First sub-vibration actuator 50 and second sub-vibration actuator 60 output sound mainly in the frequency band from 40 Hz to 90 Hz (low-frequency vibration), for example. For example, first sub-vibration actuator 50 and second sub-vibration actuator 60 may have a configuration similar to that of first vibration actuator 130. No tweeters are provided in first sub-vibration actuator 50 and second sub-vibration actuator 60.

Second vibration face S2 and third vibration face S3 may be on the same vibration face (at different locations on the same vibration face of the same member), or may be on different vibration faces. Second vibration face S2 and third vibration face S3 may each be on the same vibration face as first vibration face S1, or may each be on a vibration face different from first vibration face S1.

Low-frequency generator 122 in signal processing device 20 may further generate a low-frequency signal to be outputted to first sub-vibration actuator 50 and second sub-vibration actuator 60. For example, this low-frequency signal may be generated in the method illustrated in FIG. 6B.

Here, with reference to FIG. 9, an installation example of first sub-vibration actuator 50 and second sub-vibration actuator 60 will be described. FIG. 9 is a diagram illustrating an installation example of first sub-vibration actuator 50 and second sub-vibration actuator 60 according to the present variation. FIG. 9 illustrates an example in which first sub-vibration actuator 50 and second sub-vibration actuator 60 are provided in cushion member 110 for vehicle seat 100 in a vehicle. A certain area of cushion member 110 including the portion in contact with first sub-vibration actuator 50 is second vibration face S2. A certain area of cushion member 110 including the portion in contact with second sub-vibration actuator 60 is third vibration face S3. First sub-vibration actuator 50 and second sub-vibration actuator 60 may also be embedded in vehicle seat 100.

As illustrated in FIG. 9, first sub-vibration actuator 50 and second sub-vibration actuator 60 are provided in cushion member 110 for vehicle seat 100.

Cushion member 110 is what is called a lower back pad, which comes into contact with a person's lower back portion when the person is seated in the seat. Cushion member 110 contacts the lower back portion of the person being seated.

First sub-vibration actuator 50 and second sub-vibration actuator 60 output low-frequency vibration toward the person's lower back portion. For example, first sub-vibration actuator 50 and second sub-vibration actuator 60 output sound in the frequency band from 40 Hz to 90 Hz (low-frequency vibration).

First sub-vibration actuator 50 and second sub-vibration actuator 60 need not necessarily be provided to come into contact with the lower back portion and may also be provided to come into contact with at least one of the hips portion or the thighs portion of a person when the person is seated or recumbent. First sub-vibration actuator 50 and second sub-vibration actuator 60 may be provided in a cushion member placed on the seating surface of vehicle seat 100 or may be embedded under the seating surface, and may be configured to output low-frequency vibration toward the person's hips portion or thighs portion.

Thus, low-frequency vibration can be outputted toward at least one of the lower back portion, hips portion, or thighs portion of the person. This makes the person's body feel the vibration and can provide an additional bassy feel. Further, the low-frequency vibration can improve the person's blood flow more effectively.

First sub-vibration actuator 50 and second sub-vibration actuator 60 may also be provided to come into contact with a person's upper back when the person is seated or recumbent.

### Application Examples

Loudspeaker system 1 illustrated in each of the above embodiment and variations may be disposed in a vehicle, for example a car, an aircraft, or a watercraft. For example, loudspeaker system 1 may be a seat in a vehicle. Loudspeaker system 1 is not limited to a seat disposed in a vehicle and may be a seat disposed in a movie theater, any other theater, or a meeting room, or may be a stool, chair, sofa, or massage chair having a cushion member.

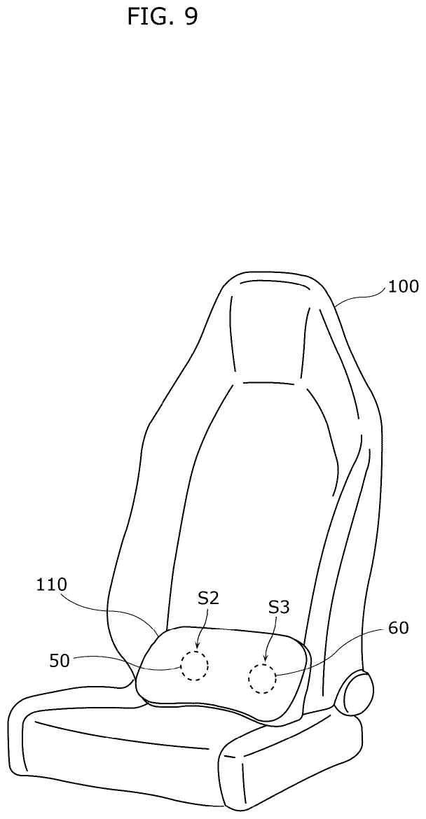

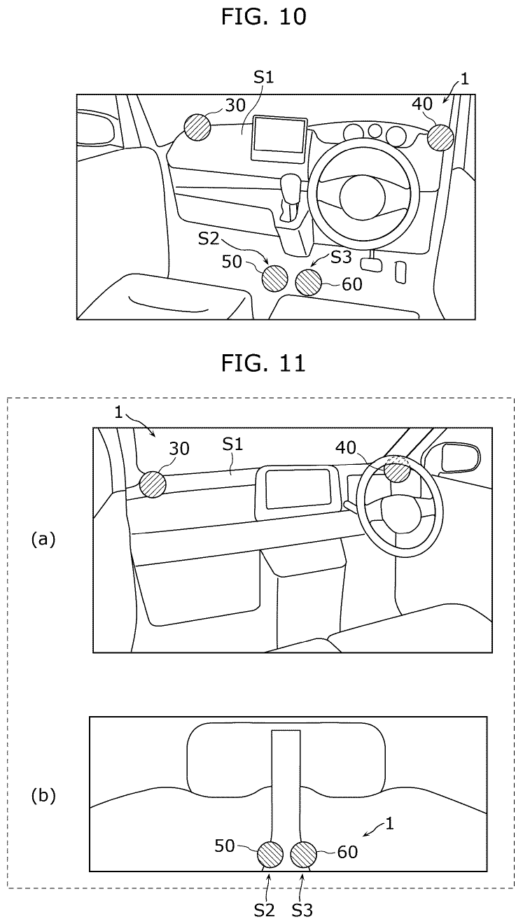

With reference to FIGS. 10 to 13, application examples of loudspeaker system 1 will be described below. FIGS. 10 to 13 are diagrams illustrating application examples of loudspeaker system 1 according to the embodiment and variations. FIGS. 10 to 13 schematically illustrate the dispositions of the tweeters and the vibration actuators of loudspeaker system 1. In FIG. 11, (a) is a view of an instrument panel of a vehicle, and (b) is a view of front seats viewed downward from above, showing the backrests and seating surfaces of driver's and passenger seats. In FIGS. 10 to 13, the surfaces (portions) where the vibration actuators are installed are examples of vibration faces (first vibration face S1, second vibration face S2, and third vibration face S3).

As illustrated in FIGS. 10 and 11, loudspeaker system 1 may be provided in a vehicle. In loudspeaker system 1, first loudspeaker 30 and second loudspeaker 40 may be provided in the upper part (e.g., at the opposite ends of the upper part) of the instrument panel, and first sub-vibration actuator 50 and second sub-vibration actuator 60 may be provided below first loudspeaker 30 and second loudspeaker 40. The upper part of the instrument panel may be, for example, the top surface of the instrument panel or may be positions above predetermined structures (e.g., cup holders) provided on the instrument panel.

First loudspeaker 30 and second loudspeaker 40 are, for example, provided to output sound from front of a person being seated toward the person.

In this case, the instrument panel is first vibration face S1.

As illustrated in FIG. 10, first sub-vibration actuator 50 and second sub-vibration actuator 60 may be provided in the lower part of the center console. In this case, in the lower part of the center console, a certain area including the portion in contact with first sub-vibration actuator 50 is second vibration face S2, and a certain area including the portion in contact with second sub-vibration actuator 60 is third vibration face S3.

As illustrated in FIG. 11, first sub-vibration actuator 50 and second sub-vibration actuator 60 may be provided in between the driver's seat and the passenger seat (e.g., on the floor under the front seats). In this case, on the floor under the front seats, a certain area including the portion in contact with first sub-vibration actuator 50 is second vibration face S2, and a certain area including the portion in contact with second sub-vibration actuator 60 is third vibration face S3.

First sub-vibration actuator 50 and second sub-vibration actuator 60 may be provided on the instrument panel at positions below first loudspeaker 30 and second loudspeaker 40 (e.g., on the side surfaces of cup holders provided on the instrument panel). First sub-vibration actuator 50 and second sub-vibration actuator 60 may be provided on a B-pillar, which is a pillar between the front seats and the back seats (e.g., in the lower part of the B-pillar), or may be provided in a lower back pad on the driver's seat (e.g., see FIG. 9).

It should be noted that first loudspeaker 30 and second loudspeaker 40 may be provided at a position other than in the instrument panel.

As above, because loudspeaker system 1 provides a wider sound field by virtue of the tweeters, the system allows the vibration actuators to be installed at positions where they cannot be installed conventionally. That is, the system increases the degree of freedom of positions where the tweeters and the vibration actuators are installed.

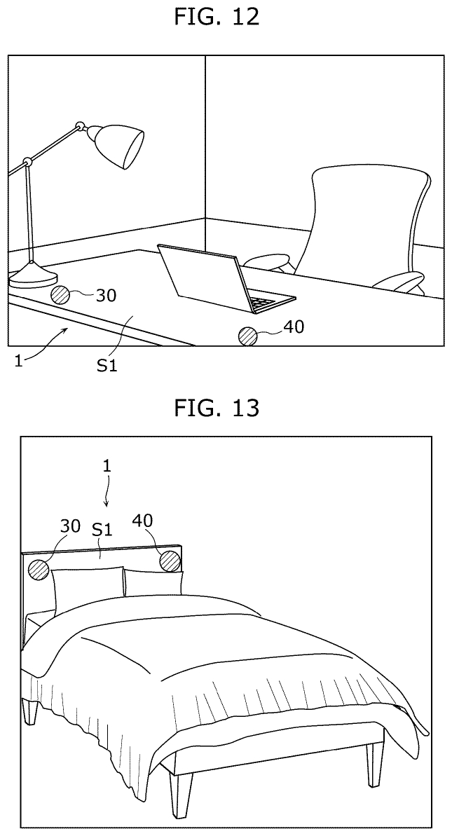

As illustrated in FIG. 12 and FIG. 13, loudspeaker system 1 may be provided in a house, an office, and so on.

As illustrated in FIG. 12, first loudspeaker 30 and second loudspeaker 40 may be provided in a desk used in a house or an office. For example, first loudspeaker 30 and second loudspeaker 40 are disposed, a predetermined distance away from each other, on top of a desk. Furthermore, although not illustrated in the figure, first sub-vibration actuator 50 and second sub-vibration actuator 60 may be embedded in a chair, or may be provided in a lower back pad used in the chair. In this case, the tabletop of the desk is first vibration face S1.

As illustrated in FIG. 13, first loudspeaker 30 and second loudspeaker 40 may be provided at opposite sides of a headboard of a bed. In this case, the headboard is first vibration face S1.

### Other Embodiments

Although loudspeaker system 1, and so on, according to one or more aspects has been described above based on the foregoing embodiments, and so on, the present disclosure is not limited to the foregoing embodiments, and so on. Forms realized by various modifications to the embodiments conceived by a skilled person as well as forms realized by a combination of the constituent elements in different embodiments, so long as they do not depart from the essence of the present disclosure, may be included in the present disclosure.

For example, each of the loudspeakers and each of the sub-vibration actuators of loudspeaker system 1 according to the foregoing embodiments, and so on, may be embedded in a structure in advance or may be retrofitted to the structure.

Furthermore, in the foregoing embodiment, and so on, an example in which first vibration actuator 130 and first tweeter 230 are provided integrally as first loudspeaker 30, first vibration actuator 130 and first tweeter 230 may be disposed separated from each other.

Furthermore, as long as there is at least one loudspeaker, there is no particular limitation as to the number of loudspeakers, which include a vibration actuator and a tweeter, that are included in loudspeaker system 1 according to the foregoing embodiments, and so on,

Furthermore, the methods of generating an ultrasonic signal and a low-frequency signal described in the foregoing embodiments, and so on, are mere examples, and are not limited to the above-described methods. As long as the above-described ultrasonic signal and low-frequency signal can be generated, the ultrasonic signal and the low-frequency signal may be generated by methods other than those describe above.

Moreover, in the above embodiments, each the constituent elements may be implemented as dedicated hardware or may be realized by executing a software program suited to such constituent element. Alternatively, the constituent elements may be implemented by a program executor such as a central processing unit (CPU) or a processor reading out and executing the software program recorded in a recording medium such as a hard disk or a semiconductor memory.

Furthermore, the processing order of executing the steps shown in the flowcharts is a mere illustration for specifically describing the present disclosure, and thus may be an order other than the order shown. Also, one or more of the steps may be executed simultaneously (in parallel) with another step, or one or more of the steps need not necessarily have to be executed.

Moreover, the divisions of the functional blocks shown in the block diagrams are mere examples, and thus a plurality of functional blocks may be implemented as a single functional block, or a single functional block may be divided into a plurality of functional blocks, or one or more functions may be moved to another functional block. Also, the functions of a plurality of functional blocks having similar functions may be processed by single hardware or software in a parallelized or time-divided manner.

Furthermore, signal processing device 20 according to the foregoing embodiments, and so on, may be implemented as a single device or may be implemented by a plurality of devices. When signal processing device 20 is implemented by a plurality of devices, each of the constituent elements included in signal processing device 20 may be distributed to the plurality of devices in any manner. When signal processing device 20 is implemented by a plurality of devices, the method of communication between the plurality of devices is not particularly limited, and may be wireless communication or wired communication. Furthermore, a combination of wireless and wired communication may be used between the devices.

Furthermore, each of the constituent elements described in the foregoing embodiments, and so on, may be implemented as software, and may typically be implemented as a large-scale integration (LSI) circuit, which is an integrated circuit (IC). The constituent elements may be implemented by individual chips, or some or all of the components may be implemented by a single chip. Although the integrated circuit implementing these constituent elements is referred to as an LSI here, the integrated circuit may be referred to as an IC, a system LSI, a super LSI, or an ultra LSI depending on the scale of integration. Moreover, a method of implementation of the constituent elements using an integrated circuit is not limited to application of an LSI. The elements may be implemented by a dedicated circuit (a general-general purpose circuit executing a dedicated program) or a general-purpose processor. It is also possible to use a field programmable gate array (FPGA) that can be programmed after being manufactured, or a reconfigurable processor in which connection and setting of circuit cells in an LSI can be reconfigured. Furthermore, when a circuit integration technology that replaces LSIs comes along owing to advances of the semiconductor technology or to a separate derivative technology, the constituent elements may understandably be integrated using that technology.

The system LSI is a super multifunctional LSI manufactured by integrating a plurality of processing units onto a single chip. More specifically, the system LSI is a computer system configured with a microprocessor, a ROM, a RAM, and so on. The ROM stores a computer program. The microprocessor operates according to the computer program so that a function of the system LSI is achieved.

Furthermore, one aspect of the present disclosure may be a computer program for causing a computer to execute each of the characteristic steps included in the signal processing method illustrated in any one of FIG. 5, FIG. 6A, and FIG. 6B.

Moreover, for example, an aspect of the present disclosure may be a non-transitory computer-readable recording medium having recorded thereon such a program. For example, such a program may be distributed or circulated by being recorded on the recording medium. For example, by installing the distributed program into another device that includes a processor, and causing the processor to execute the program, it is possible to cause the device to perform the above-described processes.

### Further Information about Technical Background to this Application

The disclosure of the following patent application including specification, drawings, and claims is incorporated herein by reference in its entirety: Japanese Patent Application No. 2023-151643 filed on Sep. 19, 2023.

### INDUSTRIAL APPLICABILITY

The present disclosure is useful to loudspeaker systems that reproduce sound.

1. A loudspeaker system comprising:
a vibration actuator that is fixed to a first vibration face and imparts vibration to the first vibration face to cause the first vibration face to emit sound; and
a tweeter that outputs sound in a high-frequency range.

2. The loudspeaker system according to claim 1, further comprising:
a first sub-vibration actuator that is fixed to a second vibration face and imparts vibration to the second vibration face to cause the second vibration face to emit sound; and
a second sub-vibration actuator that is fixed to a third vibration face and imparts vibration to the third vibration face to cause the third vibration face to emit sound.

3. The loudspeaker system according to claim 2, wherein
the first sub-vibration actuator and the second sub-vibration actuator are provided in a cushion member that a lower back portion of a person comes into contact with when the person is seated on a seat on which the cushion member is placed, and
the first sub-vibration actuator and the second sub-vibration actuator output sound toward the lower back portion.

4. The loudspeaker system according to claim 1, wherein
the tweeter is disposed overlapping with the vibration actuator when viewed from an axial direction of the vibration actuator.

5. The loudspeaker system according to claim 1, wherein
the tweeter is disposed side by side with the vibration actuator when viewed from an axial direction of the vibration actuator.

6. The loudspeaker system according to claim 1, wherein
the sound in the high-frequency range outputted by the tweeter includes, from among a sound in an audible frequency range and a sound in an inaudible frequency range higher than the audible frequency range, at least the sound in the inaudible frequency range.

7. The loudspeaker system according to claim 6, wherein
the sound in the high-frequency range outputted by the tweeter further includes the sound in the audible frequency range.

8. The loudspeaker system according to claim 4, wherein
the tweeter is disposed at a position corresponding to a central portion of the vibration actuator when viewed from an axial direction of the vibration actuator.

9. The loudspeaker system according to claim 8, further comprising:
an elastic member disposed between the tweeter and the vibration actuator.

10. The loudspeaker system according to claim 2, wherein
the loudspeaker system is provided in a vehicle.

11. The loudspeaker system according to claim 10, wherein
the first vibration face is an instrument panel of the vehicle,
the first sub-vibration actuator and the second sub-vibration actuator are provided below the vibration actuator and the tweeter.

12. The loudspeaker system according to claim 1, wherein
wherein the loudspeaker system is provided in a desk.

13. The loudspeaker system according to claim 2, wherein
the first sub-vibration actuator and the second sub-vibration actuator output low-frequency vibration.

14. The loudspeaker system according to claim 13, wherein
the low-frequency vibration includes vibration in a frequency band of at least 40 Hz and at most 90 Hz.

15. The loudspeaker system according to claim 2, wherein
the first sub-vibration actuator and the second sub-vibration actuator each include no diaphragm.

16. A signal processing device comprising:
a signal obtainer that obtains sound source data;
an ultrasonic generator that generates an ultrasonic signal for ultrasound, based on the sound source data obtained; and
a low-frequency generator that generates a low-frequency signal for low-frequency vibration, based on the sound source data obtained, wherein
the ultrasonic generator:
adjusts a pitch of the sound source data by a factor of n, n being a real number greater than 1;
extracts a first frequency component included in the sound source data whose pitch has been adjusted by the factor of n, the first frequency component being greater than or equal to 20 kHz; and
generates the ultrasonic signal by adding the first frequency extracted to the sound source data obtained, and
the low-frequency generator:
adjusts the pitch of the sound source data obtained by a factor of 1/l, l being a real number greater than 1;
extracts a second frequency component included in the sound source data whose pitch has been adjusted by the factor of 1/l, the second frequency component being less than or equal to 90 Hz; and
generates the low-frequency signal by adding the second component extracted to the sound source data obtained.

17. The signal processing device according to claim 16, further comprising:
an outputter that outputs the ultrasonic signal generated to a tweeter included in a loudspeaker system, and outputs the low-frequency signal generated to a vibration actuator included in the loudspeaker system, the tweeter outputting sound in a high-frequency range, the vibration actuator being fixed to a first vibration face and imparting vibration to the first vibration face to cause the first vibration face to emit sound.

18. A signal processing method comprising:
obtaining sound source data;
generating an ultrasonic signal for ultrasound, based on the sound source data obtained; and
generating a low-frequency signal for low-frequency vibration, based on the sound source data obtained, wherein
in the generating of the ultrasonic signal:
a pitch of the sound source data is adjusted by a factor of n, n being a real number greater than 1;
a first frequency component included in the sound source data whose pitch has been adjusted by the factor of n is extracted, the first frequency component being greater than or equal 20 kHz; and
the ultrasonic signal is generated by adding the first frequency extracted to the sound source data obtained, and
in the generating of the low-frequency signal:
the pitch of the sound source data obtained is adjusted by a factor of 1/l, l being a real number greater than 1;
a second frequency component included in the
sound source data whose pitch has been adjusted by the factor of 1/l is extracted, the second frequency component being less than or equal to 90 Hz; and
the low-frequency signal is adjusted by adding the second component extracted to the sound source data obtained.
